(19) United States
(12) Patent Application Publication
(10) Pub. No.: US 2026/0122603 A1
(43) Pub. Date: Apr. 30, 2026

(54) GENERATING DEPTH MAP OF AN ENVIRONMENT IN A WIRELESS COMMUNICATION SYSTEM

(71) Applicant: Samsung Electronics Co., Ltd., Gyeonggi-do (KR)

(72) Inventors: Shubham KHUNTETA, Bangalore (IN); Avani AGRAWAL, Bangalore (IN); Guddeti Yeswanth REDDY, Bangalore (IN); Ashok Kumar Reddy CHAVVA, Bangalore (IN)

(21) Appl. No.: 19/117,839

(22) PCT Filed: Oct. 30, 2023
(86) PCT No.: PCT/KR2023/017014

§ 371 Date: Apr. 2, 2025

(30) Foreign Application Priority Data
Oct. 31, 2022 (IN) 202241061810
Oct. 6, 2023 (IN) 202241061810

(51) Int. Cl. H04W 64/00; H04L 41/16; H04W 4/38

(52) U.S. Cl. CPC H04W 64/00; H04L 41/16; H04W 4/38

(57) ABSTRACT

The present disclosure relates to a communication method and system for converging a 5th-Generation (5G) communication system or a 6th-Generation (6G) communication system for supporting higher data rates beyond a 4th-Generation (4G) system. Embodiments herein disclose a method and a network node (110) for generating a depth map of an environment by the network node (110) in a wireless communication system. The method includes training at least one untrained ML model for at least one sub-cell area. Further, the method includes transmitting, by the network node (110), a request for at least one sub-cell area identifier to the UE (120) and receiving a response including the at least one sub-cell area identifier and input data corresponding to the at least one sub-cell area identifier: wherein the input data is a sensing data of the environment of the at least one sub-cell area. Further, the method includes generating, by the network node (110), the depth map of the at least one sub-cell area by inputting the input data of the at least one sub-cell area identifier in at least one trained ML model for predicting an event.

### TECHNICAL FIELD

The present disclosure relates to a wireless communication system, and more particularly to a method and a User Equipment (UE) for generating a depth map of an environment.

### BACKGROUND ART

Considering the development of mobile communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as Beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mm Wave bands introduced in 5G, technologies capable of securing the signal transmission distance (that is, coverage) will become more crucial. It is necessary to develop, as major technologies for securing the coverage, multiantenna transmission technologies including radio frequency (RF) elements, antennas, novel waveforms having a better coverage than OFDM, beamforming and massive MIMO, full dimensional MIMO (FD-MIMO), array antennas, and large-scale antennas. In addition, there has been ongoing discussion on new technologies for improving the coverage of terahertz-band signals, such as meta-material-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink (UE transmission) and a downlink (node B transmission) to simultaneously use the same frequency resource at the same time; a network technology for utilizing satellites, high-altitude platform stations (HAPS), and the like in an integrated manner; an improved network structure for supporting mobile nodes B and the like and enabling network operation optimization and automation and the like; an use of AI in wireless communication for improvement of overall network operation by considering AI from the initial phase of developing technologies for 6G and internalizing end-to-end AI support functions; and a next-generation distributed computing technology for overcoming the limit of UE computing ability through reachable super-high-performance communication and computing resources (MEC, clouds, and the like) over the network.

It is expected that such research and development of 6G communication systems will bring the next hyper-connected experience to every corner of life. Particularly, it is expected that services such as truly immersive XR, high-fidelity mobile hologram, and digital replica could be provided through 6G communication systems.

In general, depth maps are typically generated by depth sensors including, but not limited to, a stereo camera or a lidar sensor. The depth sensors measures a distance to objects in a scene and reconstructs the depth maps of the objects and the scenes in a 3D model. The depth sensors produce high resolution and high accuracy depth maps, however the depth sensors works for limited range.

The conventional methods and systems, overcomes the issues of limited range with a Radio Frequency (RF) for depth map generation. The RF based depth map generation uses existing communication infrastructure like spectrum, devices and protocols to perform both communication and sensing. However the conventional methods and systems faces issues with signal distortions to detect location, movement and even orientation of the objects. Further, the RF based depth maps generates depth map in a lower resolution and lesser accuracy than the depth maps that is generated by the depth sensors including cameras or lidar sensors.

Thus, it is desired to address the above mentioned disadvantages or other shortcomings or at least provide a useful alternative to generate high resolution depth map using the RF.

The principal object of the embodiments herein is to provide a method and a network node for generating a depth map of an environment in a wireless communication system. The method includes generating a depth map of one or more sub-cell areas by inputting input data of one or more sub-cell area identifiers in at least one trained ML model.

Another object of the embodiments herein is to train the at least one untrained ML model for the at least one sub-cell area, wherein a UE trains the at least one untrained ML model during a training phase.

Another object of the embodiments herein is to receive at least one channel data in a bi-static format, where the bi-static format includes data of the RF signal that is received directly or indirectly from at least one transmitter. The method further includes determine the input data by converting the channel data from bi-static format to mono-static format.

### DISCLOSURE OF INVENTION

### Technical Problem

The present disclosure relates to wireless communication systems and, more specifically, the invention relates to generating depth map of an environment in a wireless communication system.

### Solution to Problem

Accordingly the embodiments herein disclose a method for generating a depth map of an environment. The method includes training, by the network node, at least one untrained ML model for at least one sub-cell area. The method includes transmitting, by the network node, a request for at least one sub-cell area identifier to a User Equipment (UE). Further, the method includes receiving, by the network node, a response including the at least one sub-cell area identifier and input data corresponding to the at least one sub-cell area identifier; wherein the input data is a sensing data of the environment of the at least one sub-cell area. Further, the method includes generating, by the network node, the depth map of the at least one sub-cell area by inputting the input data of the at least one sub-cell area identifier in at least one trained ML model.

In an embodiment, the method includes transmitting, by the network node, a location request for the at least one sub-cell area identifier of the at least one sub-cell area to the UE. Further, the method includes receiving, by the network node, a location response including the at least one sub-cell area identifier of the UE. Further, the method includes transmitting, by the network node, the at least one untrained ML model corresponding to the at least one sub-cell area identifier to the UE for training. Further, the method includes receiving, by the network node, the at least one trained mode corresponding to the at least one sub-cell area identifier from the UE.

In an embodiment, training the at least one untrained ML model is updating at least one of parameter by the UE based on the sensing data.

In an embodiment, the network node stores plurality of trained ML models of plurality of sub-cell areas, wherein the network node uses the stored plurality of trained ML models for virtually selecting beam without sending actual beams in physical environment.

Accordingly the embodiments herein disclose the method for generating the depth map of an environment. Further, the method includes requesting, by the UE, at least one trained ML model of at least one sub-cell area by transmitting at least one sub-cell area identifier to the network node. Further, the method includes receiving, by the UE, the at least one trained ML model of the at least one sub-cell area corresponding to the at least one sub-cell area identifier from the network node. Further, the method includes determining, by the UE, input data by sensing the environment of the at least one sub-cell area. Further, the method includes generating, by the UE, the depth map of the at least one sub-cell area by inputting the input data in the at least one trained ML model.

In an embodiment, the method includes receiving, by the UE, at least one channel data in a bi-static format; wherein the bi-static format includes data of the RF signal that is received directly or indirectly from at least one transmitter. Further, the method includes determining, by the UE, the input data by converting the channel data from bi-static format to mono-static format.

In an embodiment, the UE trains at least one untrained ML model during a training phase.

In an embodiment, the method includes generating, by the UE, sensing data based on sensing of an environment using the at least one untrained ML model. Further, the method includes validating, by the UE, the sensing data with a Light Detecting and Ranging (LiDAR) data. Further, the method includes determining, by the UE, whether the sensing data meets a threshold. Further, the method includes updating the parameters in at least one of convolution layers and up-sampling layers of the at least one untrained ML model when the sensing data does not meets the threshold. Further, the method includes considering the at least one untrained ML model as trained ML model when the sensing data meets the threshold.

Accordingly the embodiments herein disclose the network node for generating the depth map of the environment. The network node comprises a memory, a processor; and a network node depth map controller, communicatively coupled to the memory and the processor. The network node depth map controller is configured to train at least one untrained ML model for at least one sub-cell area. Further, the network node depth map controller is configured to transmit the request for at least one sub-cell area identifier to the UE. Further, the network node depth map controller is configured to receive the response including the at least one sub-cell area identifier and input data corresponding to the at least one sub-cell area identifier; wherein the input data is the sensing data of the environment of the at least one sub-cell area. Further, the network node depth map controller is configured to generate the depth map of the at least one sub-cell area by inputting the input data of the at least one sub-cell area identifier in at least one trained ML model.

Accordingly the embodiments herein disclose the UE for generating the depth map of the environment. The UE comprises a memory, a processor; and a UE depth map controller, communicatively coupled to the memory and the processor. The UE depth map controller is configured to request at least one trained ML model of at least one sub-cell area by transmitting at least one sub-cell area identifier to the network node. Further, the UE depth map controller is configured to receive the at least one trained ML model of the at least one sub-cell area corresponding to the at least one sub-cell area identifier from the network node. Further, the UE depth map controller is configured to determine input data by sensing the environment of the at least one sub-cell area. Further, the UE depth map controller is configured to generate the depth map of the at least one sub-cell area by inputting the input data in the at least one trained ML model.

These and other aspects of the embodiments herein will be better appreciated and understood when considered in conjunction with the following description and the accompanying drawings. It should be understood, that the following descriptions, while indicating preferred embodiments and numerous specific details thereof, are given by way of illustration and not of limitation. Many changes and modifications may be made within the scope of the embodiments herein without departing from the invention thereof, and the embodiments herein include all such modifications.

### Advantageous Effects of Invention

Advantages, and salient features of the invention will become apparent to those skilled in the art from the following detailed description, which, taken in conjunction with the annexed drawings, discloses exemplary embodiments of the invention.

### BRIEF DESCRIPTION OF DRAWINGS

These and other features, aspects, and advantages of the present method are illustrated in the accompanying drawings, throughout which like reference letters indicate corresponding parts in the various figures. The embodiments herein will be better understood from the following description with reference to the drawings, in which:

FIG. 1 is a block diagram of a network node and a UE for generating a depth map of an environment in a wireless communication system, according to the embodiments as disclosed herein;

FIG. 2 is a flow chart illustrating a method for generating the depth map of the environment, according to the embodiments as disclosed herein;

FIG. 3 is an example illustrating an inference using RF communication signal, according to the embodiments as disclosed herein;

FIG. 4 is an example illustrating depth map of a physical world, according to the embodiments as disclosed herein;

FIG. 5 is an example illustrating a base station that is connected with multiple UE for estimating depth map for smaller areas, according to the embodiments as disclosed herein;

FIG. 6 is a is an example illustrating estimation of depth map for the UE for each smaller areas having fixed transmitter and moving receiver, according to the embodiments as disclosed herein;

FIG. 7 is a flow chart illustrating end to end process in generating the depth map of the environment, according to the embodiments as disclosed herein;

FIG. 8 is a flow chart illustrating steps involved during a training phase of untrained ML model, according to the embodiments as disclosed herein;

FIG. 9 is a flow chart illustrating steps involved during an inference phase of a trained ML model, according to the embodiments as disclosed herein;

FIG. 10 is an example illustrating a base station that is connected with multiple UE during the training Phase of ML model, according to the embodiments as disclosed herein;

FIG. 11 is a schematic diagram illustrating conversion of bi-static format data to mono-static format data, according to the embodiments as disclosed herein;

FIG. 12 is a schematic diagram illustrating conversion of the bi-static format data to the mono-static format data with pre-processing, according to the embodiments as disclosed herein;

FIG. 13 is a schematic diagram illustrating overview of the pre-processing, according to the embodiments as disclosed herein;

FIG. 14 is a schematic diagram illustrating the pre-processing with spatial transform, according to the embodiments as disclosed herein;

FIG. 15 is a schematic diagram illustrating the pre-processing with spatial transform and angle of arrival information, according to the embodiments as disclosed herein;

FIG. 16 is a schematic diagram illustrating the pre-processing with finding Line Of Sight (LOS), according to the embodiments as disclosed herein;

FIG. 17 is a schematic diagram illustrating the pre-processing with removing effort of transmission, according to the embodiments as disclosed herein;

FIG. 18 is a schematic diagram illustrating the pre-processing with the removing effort of transmission and the angle of arrival information, according to the embodiments as disclosed herein;

FIG. 19 is a schematic diagram illustrating the pre-processing with rescale power, according to the embodiments as disclosed herein;

FIG. 20 is a schematic diagram illustrating the comparison of LIDAR PCD and PCD of the proposed method, according to the embodiments as disclosed herein;

FIG. 21 is a schematic diagram illustrating an input and output for ML model training, according to the embodiments as disclosed herein;

FIG. 22 is a schematic diagram illustrating a ML model architecture, according to the embodiments as disclosed herein; and

FIG. 23 is a schematic diagram testing samples with an error analysis, according to the embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly the embodiments herein disclose a method for generating a depth map of an environment. The method includes training, by the network node, at least one untrained ML model for at least one sub-cell area. The method includes transmitting, by the network node, a request for at least one sub-cell area identifier to a User Equipment (UE). Further, the method includes receiving, by the network node, a response including the at least one sub-cell area identifier and input data corresponding to the at least one sub-cell area identifier; wherein the input data is a sensing data of the environment of the at least one sub-cell area. Further, the method includes generating, by the network node, the depth map of the at least one sub-cell area by inputting the input data of the at least one sub-cell area identifier in at least one trained ML model.

Accordingly the embodiments herein disclose the method for generating the depth map of an environment. Further, the method includes requesting, by the UE, at least one trained ML model of at least one sub-cell area by transmitting at least one sub-cell area identifier to the network node. Further, the method includes receiving, by the UE, the at least one trained ML model of the at least one sub-cell area corresponding to the at least one sub-cell area identifier from the network node. Further, the method includes determining, by the UE, input data by sensing the environment of the at least one sub-cell area. Further, the method includes generating, by the UE, the depth map of the at least one sub-cell area by inputting the input data in the at least one trained ML model.

Accordingly the embodiments herein disclose the network node for generating the depth map of the environment. The network node comprises a memory, a processor; and a network node depth map controller, communicatively coupled to the memory and the processor. The network node depth map controller is configured to train at least one untrained ML model for at least one sub-cell area. Further, the network node depth map controller is configured to transmit the request for at least one sub-cell area identifier to the UE. Further, the network node depth map controller is configured to receive the response including the at least one sub-cell area identifier and input data corresponding to the at least one sub-cell area identifier; wherein the input data is the sensing data of the environment of the at least one sub-cell area. Further, the network node depth map controller is configured to generate the depth map of the at least one sub-cell area by inputting the input data of the at least one sub-cell area identifier in at least one trained ML model.

Accordingly the embodiments herein disclose the UE for generating the depth map of the environment. The UE comprises a memory, a processor; and a UE depth map controller, communicatively coupled to the memory and the processor. The UE depth map controller is configured to request at least one trained ML model of at least one sub-cell area by transmitting at least one sub-cell area identifier to the network node. Further, the UE depth map controller is configured to receive the at least one trained ML model of the at least one sub-cell area corresponding to the at least one sub-cell area identifier from the network node. Further, the UE depth map controller is configured to determine input data by sensing the environment of the at least one sub-cell area. Further, the UE depth map controller is configured to generate the depth map of the at least one sub-cell area by inputting the input data in the at least one trained ML model.

In conventional system and method for an AR use case like video calls, traditional depth map sensors like LiDAR, 3D-camera need to first estimate the depth map and then communicate that high throughput information in low latency manner to BS/router perhaps using mm-wave link for a good quality call experience. However the proposed system utilizes the mm wave link that is used to communicate to BS/router itself for sensing the depth map info making the depth map sensing and communication process more efficient compared to using other sensors like LiDAR, camera.

The conventional system and method generates depth map using LIDAR data for that the conventional system and method requires dedicated sensor hardware which is not available in legacy UEs. Unlike the conventional methods and systems, the proposed system uses only RF channel data (CIR) which is readily available in any communication enabled UE for Depth-map estimation (DME). The proposed system and method generates high resolution LIDAR Point cloud (PCD) or depth map from low resolution RF data.

Unlike the conventional methods and systems, the proposed framework that manifest the depth map possibility in the next gen systems utilizing the environmental information (obstacle information) in the commonly received communication signals.

Unlike the conventional methods and systems, the proposed system estimates the depth map of the environment by solving for the location of the obstacles using RF signals obtained in bi-static format. In Bi-static format, the RF signal from TX reflects from obstacle and then travels to RX.

Unlike the conventional methods and systems, the proposed system performs the pre-processing procedure to extract Mono-static power (MSP) seen from the perspective of a receiver in a particular location of the environment, from the traditional signals used to communicate between transmitter to receiver. The Pre-processing step handles the deterministic aspects of transforming MIMO channel data which is in bistatic format to mono-static format. This makes ML model learning faster & understandable.

Unlike the conventional methods and systems, the proposed system performs information exchange between Base-station and UEs during the training and inference phase for deploying the proposed solution.

Unlike the conventional methods and systems, the proposed system transforms the low-resolution, lower dimensional input data (MSP) into higher resolution, feature rich LiDAR data that captures surfaces of the objects, obstacles, people and the like in the surrounding environment in intricate detail via the dense point clouds using ML model. The sensing capability of the proposed system is several orders beyond elementary applications like counting people in room, locating a specific object and the like, that has been traditional done using wireless sensing.

Unlike the conventional methods and systems, the proposed system returns high resolution depth map with the lower resolution RF signals, where such depth-map is traditionally generated using LiDAR Point cloud (PCD) or camera image as input.

Unlike the conventional methods and systems, the proposed system generates LiDAR like high resolution point clouds with low resolution RF data in terms of range and angle.

Unlike the conventional methods and systems, the proposed system estimates the depth map of the environment by solving for a location of the obstacles using RF signals obtained in bi-static format. Where in Bi-static format, the RF signal from TX reflects from obstacle and then travels to RX.

Unlike the conventional methods and systems, the proposed system uses pre-processing procedure to extract MSP from the perspective of a receiver in a particular location of the environment, from the traditional signals used to communicate between transmitters to receiver. The Pre-processing step handles the deterministic aspects of transforming MIMO channel data which is in the bistatic format to the mono-static format.

Unlike the conventional methods and systems, the proposed system uses re-uses the existing RF hardware on 5G-enabled phones in an ISAC format to extract spatial information of the surroundings. The proposed system is deployed with the existing hardware with very minimal additions of few protocols.

Unlike the conventional methods and systems, the proposed system enables creation of digital twin by leveraging the existing smart things ecosystem by integrating the readily available RF sensor data from multiple sensors. The proposed system also enables activity recognition using only wireless RF signals such as pose estimation, human activity, fall detection, and the like.

Unlike the conventional methods and systems, the proposed system integrate data from multiple sensors like camera, LiDAR, RF and the like, for creating a robust digital twin which enables virtual testing, validation and self-optimization of smart city B5G networks.

Unlike the conventional methods and systems, the proposed system enables AR/VR in absence of specialized hardware like LiDAR, 3D cameras in COTS hardware using mmWave signals in B5G.

Unlike the conventional methods and systems, the proposed system provides rich point cloud data enabling sensing of higher level activity like human gesture, pedestrian movement and the like from widely available RF data.

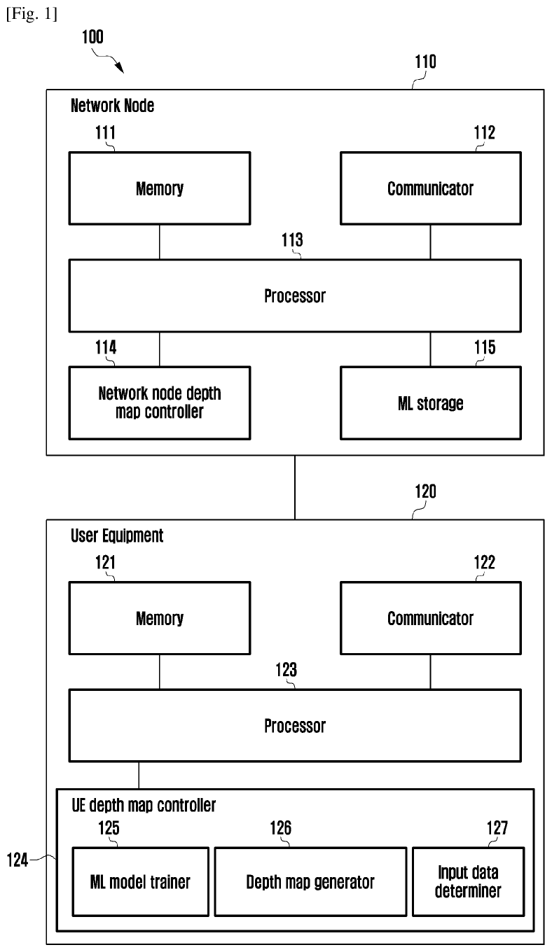

Referring now to the drawings and more particularly to FIGS. 1 through 25, where similar reference characters denote corresponding features consistently throughout the figure, these are shown preferred embodiments.

FIG. 1 is a block diagram of a network node (110) and a UE (120) for generating a depth map of an environment in a wireless communication system (100), according to the embodiments as disclosed herein.

In an embodiment, the network node (110) includes a memory (111), a processor (113), a communicator (112), a Network node depth map controller (114), and a ML storage (115).

The memory (111) is configured to store image frames representative of stages of the event. The memory (111) includes non-volatile storage elements. Examples of such non-volatile storage elements include magnetic hard discs, optical discs, floppy discs, flash memories, or forms of electrically programmable memories (EPROM) or electrically erasable and programmable (EEPROM) memories. In addition, the memory (111), in some examples, is considered as a non-transitory storage medium. The term “non-transitory” indicates that the storage medium is not embodied in a carrier wave or a propagated signal. However, the term “non-transitory” is not interpreted that the memory (111) is non-movable. In some examples, the memory (111) is configured to store larger amounts of information. In certain examples, a non-transitory storage medium stores data that changes over time (e.g., in Random Access Memory (RAM) or cache).

The processor (113) includes one or a plurality of processors. The one or the plurality of processors is a general-purpose processor, such as a central processing unit (CPU), an application processor (AP), or the like, a graphics-only processing unit such as a graphics processing unit (GPU), a visual processing unit (VPU), and/or an ML-dedicated processor such as a neural processing unit (NPU). The processor (113) includes multiple cores and is configured to execute the instructions stored in the memory (111).

In an embodiment, the communicator (112) includes an electronic circuit specific to a standard that enables wired or wireless communication. The communicator (112) is configured to communicate internally between internal hardware components of the wearable AR device (100) and with external devices via one or more networks.

In an embodiment, the network node depth map controller (114) is configured to train at least one untrained ML model for at least one sub-cell area. Further the network node depth map controller (114) is configured to transmit a request for at least one sub-cell area identifier to the UE (120). Further the network node depth map controller (114) is configured to receive a response including the at least one sub-cell area identifier and input data corresponding to the at least one sub-cell area identifier; wherein the input data is a sensing data of the environment of the at least one sub-cell area. Further the network node depth map controller (114) is configured to generate the depth map of the at least one sub-cell area by inputting the input data of the at least one sub-cell area identifier in at least one trained ML model.

In an embodiment, the network node depth map controller (114) is configured to transmit a location request for the at least one sub-cell area identifier of the at least one sub-cell area to the UE (120). Further the network node depth map controller (114) is configured to receive a location response including the at least one sub-cell area identifier of the UE (120) and transmit the at least one untrained ML model corresponding to the at least one sub-cell area identifier to the UE (120) for training. Further the network node depth map controller (114) is configured to receive the at least one trained mode corresponding to the at least one sub-cell area identifier from the UE (120).

In an embodiment, the at least one untrained ML model is trained by updating at least one of parameter by the UE (120) based on the sensing data.

In an embodiment, the network node (110) stores plurality of trained ML models of plurality of sub-cell areas, wherein the network node (110) uses the stored plurality of trained ML models for virtually selecting beam without sending actual beams in physical environment.

The network node depth map controller (114) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

At least one of the plurality of modules/components of the network node depth map controller (114) is implemented through an ML model. A function associated with the ML model is performed through the memory (111) and the processor (113). The one or the plurality of processors (113) controls the processing of the input data in accordance with a predefined operating rule or the ML model stored in the non-volatile memory and the volatile memory. The predefined operating rule or artificial intelligence model is provided through training or learning.

Here, being provided through learning means that, by applying a learning process to a plurality of learning data, a predefined operating rule or ML model of a desired char-acteristic is made. The learning is performed in a device itself in which ML according to an embodiment is performed, and/or is implemented through a separate server/system.

The ML model consists of a plurality of neural network layers. Each layer has a plurality of weight values and performs a layer operation through determination of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

In an embodiment, the network node (110) includes a memory (121), a processor (123), a communicator (122), a UE depth map controller (124), and a ML storage (115).

The memory (121) is configured to store image frames representative of stages of the event. The memory (121) includes non-volatile storage elements. Examples of such non-volatile storage elements include magnetic hard discs, optical discs, floppy discs, flash memories, or forms of electrically programmable memories (EPROM) or electrically erasable and programmable (EEPROM) memories. In addition, the memory (121), in some examples, is considered as a non-transitory storage medium. The term “non-transitory” indicates that the storage medium is not embodied in a carrier wave or a propagated signal. However, the term “non-transitory” is not interpreted that the memory (121) is non-movable. In some examples, the memory (121) is configured to store larger amounts of information. In certain examples, a non-transitory storage medium stores data that changes over time (e.g., in Random Access Memory (RAM) or cache).

The processor (123) includes one or a plurality of processors. The one or the plurality of processors is a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (123) includes multiple cores and is configured to execute the instructions stored in the memory (121).

In an embodiment, the communicator (122) includes an electronic circuit specific to a standard that enables wired or wireless communication. The communicator (122) is configured to communicate internally between internal hardware components of the wearable AR device (100) and with external devices via one or more networks.

In an embodiment, the UE depth map controller (124) comprises a ML model trainer (125), a depth map generator (126) and an input data determiner (127)

In an embodiment, the depth map generator (126) requests at least one trained ML model of at least one sub-cell area by transmitting at least one sub-cell area identifier to a network node (110). Further, the depth map generator (126) receives the at least one trained ML model of the at least one sub-cell area corresponding to the at least one sub-cell area identifier from the network node (110). Further, the depth map generator (126) determines input data by sensing the environment of the at least one sub-cell area. Further, the depth map generator (126) generate the depth map of the at least one sub-cell area by inputting the input data in the at least one trained ML model.

In an embodiment, the input data determiner (127) receives at least one channel data in a bi-static format; wherein the bi-static format includes data of the RF signal that is received directly or indirectly from at least one transmitter. Further, the input data determiner (127) determine the input data by converting the channel data from bi-static format to mono-static format.

In an embodiment, the ML model trainer (125) trains at least one untrained ML model during a training phase.

In an embodiment, the ML model trainer (125) generates sensing data based on sensing of an environment using the at least one untrained ML model. Further, the ML model trainer (125) validates the sensing data with a Light Detecting and Ranging (LiDAR) data. Further, the ML model trainer (125) determines whether the sensing data meets a threshold. Further, the ML model trainer (125) updates the parameters in at least one of convolution layers and up-sampling layers of the at least one untrained ML model when the sensing data does not meets the threshold. Where the threshold is defined as certain percentage (for example: 1%-5%) of error between the prediction of the sensing data and the LiDar data. Further, the ML model trainer (125) considers the at least one untrained ML model as trained ML model when the sensing data meets the threshold.

The UE depth map controller (124) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

At least one of the plurality of modules/components of the UE depth map controller (124) is implemented through an ML model. A function associated with the ML model is performed through the memory (121) and the processor (123). The one or the plurality of processors (123) controls the processing of the input data in accordance with a predefined operating rule or the ML model stored in the non-volatile memory and the volatile memory. The predefined operating rule or artificial intelligence model is provided through training or learning.

Here, being provided through learning means that, by applying a learning process to a plurality of learning data, a predefined operating rule or ML model of a desired char-acteristic is made. The learning is performed in a device itself in which ML according to an embodiment is performed, and/or is implemented through a separate server/system.

The ML model consists of a plurality of neural network layers. Each layer has a plurality of weight values and performs a layer operation through determination of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

Although the FIG. 1 shows the hardware elements of the network node (110) and UE (120) but it is to be understood that other embodiments are not limited thereon. In other embodiments, the network node (110) and UE (120) includes less or more number of elements. Further, the labels or names of the elements are used for illustrative purpose and does not limit the scope of the embodiments. One or more components are combined together to perform same or substantially similar function.

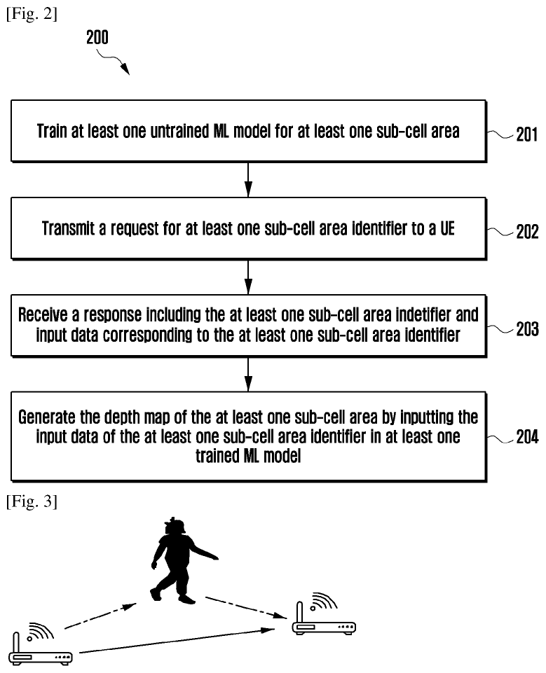

FIG. 2 is a flow chart illustrating a method for generating the depth map of the environment, according to the embodiments as disclosed herein;

At 201, the network node (110) trains at least one untrained ML model for at least one sub-cell area.

At 202, the network node (110) transmit a request for at least one sub-cell area identifier to a UE (120)

At 203, the network node (110) receives a response including the at least one sub-cell area identifier and input data corresponding to the at least one sub-cell area identifier

At 204, the network node (110) generate the depth map of the at least one sub-cell area by inputting the input data of the at least one sub-cell area identifier in at least one trained ML model.

In an embodiment, the network node (110) is otherwise referred as base station, network element, access point and the like.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the embodiments.

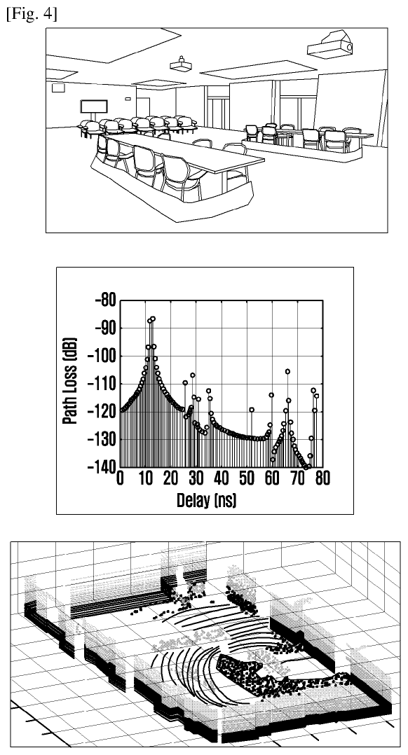

FIG. 3 is an example illustrating an inference using RF communication signal, according to the embodiments as disclosed herein.

The RF communication signal uses existing communication infrastructure like spectrum, devices and protocols to perform both communication and sensing, where inferences were made on signal distortions to detect including, but not limited to, location, movement and orientation of people or obstacles.

FIG. 4 is an example illustrating depth map of a physical world, according to the embodiments as disclosed herein.

In an embodiment, the proposed system estimates the depth map of an environment (401) at each receiver position, using mm-wave signals and the ML model.

In an embodiment, the proposed system trains the ML model that takes MIMO channel impulse response (402) as input and generates Lidar point cloud (403) as the output.

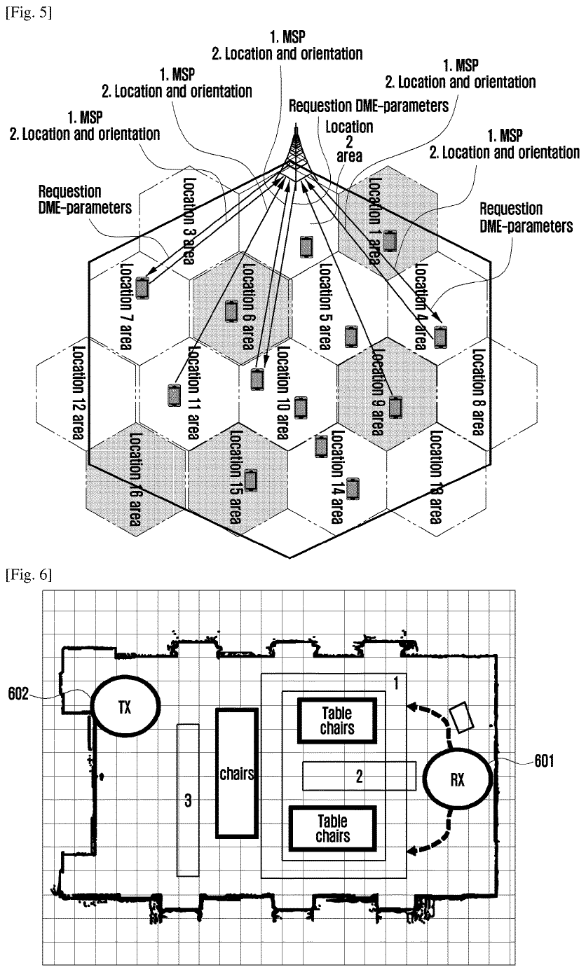

FIG. 5 is an example illustrating a base station that is connected with multiple UE (120) for estimating depth map for smaller areas, according to the embodiments as disclosed herein. A cell area in FIG. 5 with one BS and many UEs in the cell area. The cell area divides into smaller location areas called as sub-cell area as determination of depth map for the smaller areas is feasible, where some of the smaller location areas are indoor and some are outdoor.

BS B is situated in a cell and the cell is divided into multiple sub areas indoor and outdoor: A_=1 . . . . Each of these areas are occupied with multiple UEs: UE_([j,A]_i): j=0 . . . . M, i=1 . . . . N. The ML model is trained for smaller areas for the depth map estimation.

Information exchange for depth map estimation model at BS is followed as:
BS->UEs: Request for DME-info
UEs->BS: Send 1. MSP from pre-processing [B1]
2. Location and orientation
At BS:

For each UE (120)'s parameters:
Based on the locations, decide the location area
Run the ML model [B2] for the UE (120)'s MSP with the stored weights of that area
Infer the depth map and based on the UE (120)'s location and orientation, adjust the depth map for the location area in the GCS.
Register the depth maps estimated of all the locations to get the full depth map of the cell area

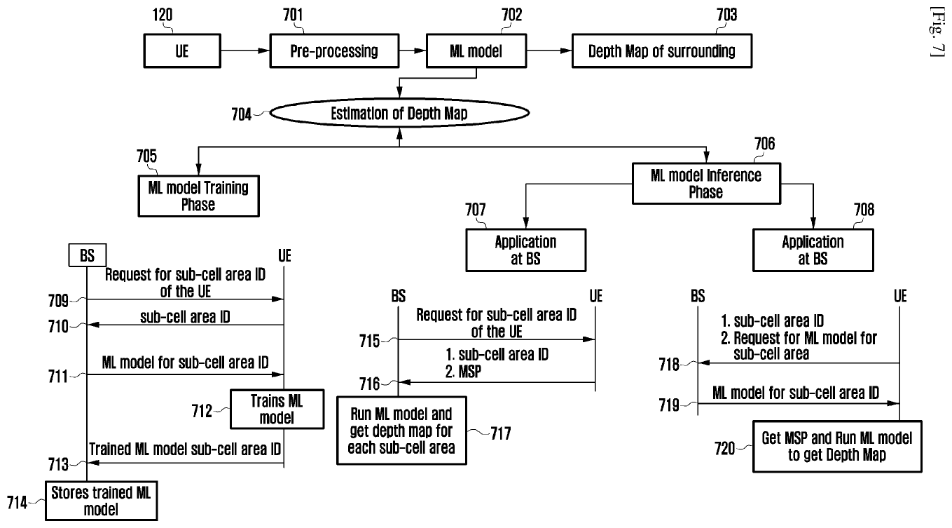

FIG. 6 is a is an example illustrating estimation of depth map for the UE (120) for each smaller areas having fixed transmitter and moving receiver, according to the embodiments as disclosed herein.

For Indoor scenario, the UE (120) estimate the depth map in the indoor setting. FIG. 6 discloses a room in which measurements are taken. The room have a transmitter at a fixed location on the left and a receiver moving in different areas of room. The ob-servation of the room changes with receiver location and orientation. The location and orientation of the transmitter and the receiver unknown makes the problem more com-plicated.

FIG. 7 is a flow chart illustrating end to end process in generating the depth map of the environment, according to the embodiments as disclosed herein.

The UE (120) converts the tap-channel into mono-static power of reflections (MSP) through pre-processing (701). Further, the ML model (702) is trained at UE (120) and inference at both BS and UE (120) to predict the depth map (703). The estimation of depth map (704) consist of ML model training phase (705) and ML model inference phase (706).

The steps follows in the ML model training phase (705) is follows:

At 709, the base station transmits the location request for the at least one sub-cell area identifier of the at least one sub-cell area to the UE (120).

At 710, the base station receives a location response including the at least one sub-cell area identifier of the UE (120);

At 711, the base station transmits the at least one untrained ML model corresponding to the at least one sub-cell area identifier to the UE (120) for training, where at 712, the UE (120) trains the ML model.

At 711, the base station receives the at least one trained mode corresponding to the at least one sub-cell area identifier from the UE (120).

At 714, the base station stores the trained ML model.

The steps follows in the ML model Inference Phase (706) and the application at the base station (707) are follows:

At 715, the base station transmits a request for at least one sub-cell area identifier to the UE.

At 716, the base station receives a response including the at least one sub-cell area identifier and input data corresponding to the at least one sub-cell area identifier; wherein the input data is the sensing data of the environment of the at least one sub-cell area. In an embodiment, the input data is Mono-Static Power of reflections (MSP).

At 717, the base station generates the depth map of the at least one sub-cell area by inputting the input data of the at least one sub-cell area identifier in at least one trained ML model.

The steps follows in the ML model Inference Phase (706) and the application at the US (708) are follows:

At 718, the UE (120) requests the at least one trained ML model of the at least one sub-cell area by transmitting the at least one sub-cell area identifier to the base station.

At 719, the UE (120) receives the at least one trained ML model of the at least one sub-cell area corresponding to the at least one sub-cell area identifier from the base station.

At 720, the UE (120) determine MSP by sensing the environment of the at least one sub-cell area and generate the depth map of the at least one sub-cell area by inputting the MSP in the at least one trained ML model.

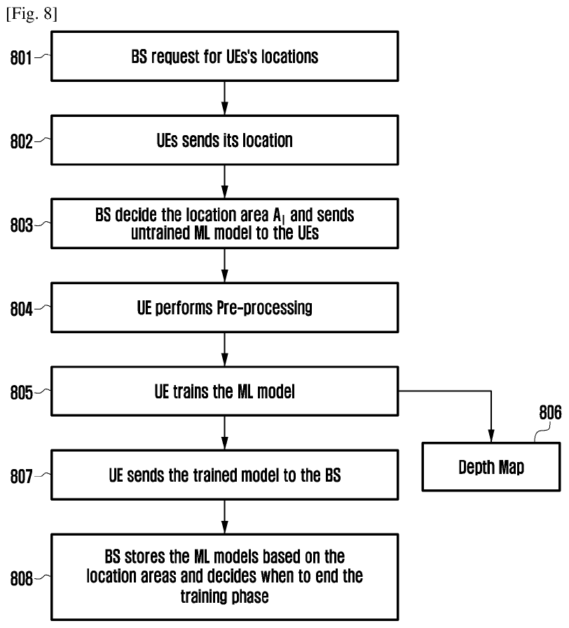

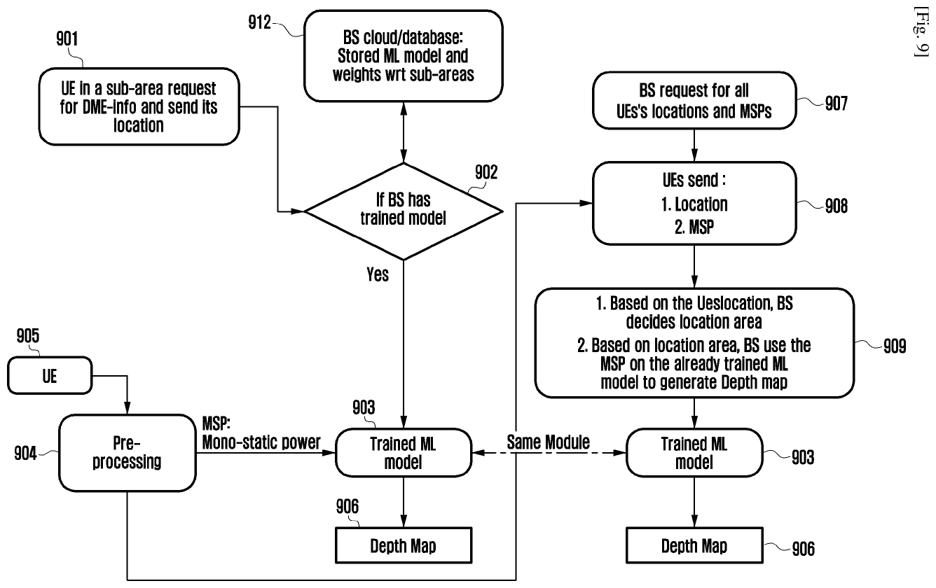

FIG. 8 is a flow chart illustrating steps involved during the training phase of the untrained ML model, according to the embodiments as disclosed herein. The ML model is trained for smaller areas for the depth map estimation.

In step 801, the base station request for the UEs about the location area. At step 802, the UEs sends their location to the base station. At 803, the BS decide the location area A, and sends untrained ML model to the UEs, wherein the BS B is situated in a cell and the cell is divided into multiple sub areas indoor and outdoor: Aᵢi=1 . . . . N Each of these areas are occupied with multiple UEs: UE_{j,A,}:j=O . . . M, i=1 . . . . N.

At 804, the UE (120) performs pre-processing and at 805, the UE (120) trains the ML model to generate depth map (at 806).

At 807, the UE (120) sends the trained model to the BS and the BS stores the ML models based on the location areas and decides when to end the training phase (at 808).

In an embodiment, during the ML model training, the UE (120) estimate the channel and pre-process it to convert it to MSP: mono-static power of the reflections at the UE (120) (at 804). MSP is used as the input to the ML model (at 805), which predict the depth map of the surrounding.

In an embodiment, the UEs send the trained ML model with respect to their location to the BS and the BS store these trained ML model. Hence during the inference phase, when any UE (120) requires the trained ML model, BS provide the trained ML model to the UE (120), so that UE (120) can estimate the depth map without a fresh training again.

FIG. 9 is a flow chart illustrating steps involved during the inference phase of the trained ML model, according to the embodiments as disclosed herein.

At 901, the UE (120) requests for DME-info, which is ML model from the BS for UE (120) based applications. The BS sends the ML model to the UE (120), using which the UE (120) generates the depth map with the MSP from pre-processing of input channel as inputs (at 904 and 903).

At 902, the BS determines whether the BS has trained model, where BS cloud or database stores the trained ML model and weights with respect to the sub-areas (at 912). The trained ML model generates the depth map (906).

At 907, the BS request from UEs the location area and MSP, which UE (120) generate from pre-processing of channel for BS based applications. The BS use the corresponding ML model on MSPs to get the corresponding depth map based on the location area.

At 909, BS decides location area based on the UEs location. Further BS use the MSP on the already trained ML model to generate Depth map based on location area. Further, parameters ‘DMEtrainingInfoRequest’, ‘DMEInferInfoRequest’ is exchanged between PHY/MAC layers of the UE and BS and involves physical layer based processing and needs standard support and add ons. Further, the sub-cell area and the MSP parameter are processed at PHY and transmission of these parameters is enabled during the depth map estimation window (i.e. when a flag for depth map estimation is enabled by the BS).

In an embodiment, the information is exchanged in the RRC Reconfiguration from BS side and UE assistance information from the UE side.

In conventional method and system, a RRCReconfiguration (BS->UE) is follows:

```
  DMEtrainingInfoRequest -IEs ::= SEQUENCE {Flag-DMETraining
  ENUMERATED {true, false} OPTIONAL,}
  DMEInferInfoRequest -IEs ::= SEQUENCE { Flag-DMEInfer
  ENUMERATED {true, false} OPTIONAL,}
  DME-MLModel -IEs ::= SEQUENCE {MLModelParams
  Model-parameter OPTIONAL,
  }
  In conventional method and system, a UE-assistanceInformation IE (UE−>BS) is
follows
  DMETrainingInfoResponse-IEs ::= SEQUENCE { UE-pos
  position value OPTIONAL,
  }
  DMEinferInfoResponse-IEs ::= SEQUENCE { UE-pos position value MSP mono-
static power OPTIONAL,
  }
  DME-TrainedModel-IEs ::= SEQUENCE { MLModelParams Model-params
OPTIONAL,
  }
  UE-DMEinferInfoResponse-IEs ::= SEQUENCE { UE-pos position value
OPTIONAL,
  }
```

In an embodiment, the details of the terms are follows:
DMEtrainingInfoRequest: Message from BS to UE for requesting to start the DME training and asking for location
DMETrainingInfoResponse: Message from UE to BS responding and sending position/area information
DMEInferInfoRequest: Message from BS to UE for requesting MSP and position area for inference at BS.
DMEInferInfoResponse: Message from UE to BS responding and sending position/area information and MSP.
UE-DMEinferInfoResponse: Message from UE to BS requesting for DME info such as ML model from BS and sending the position area info.
DME-MLModel: Message from BS to UE
After receiving DMETrainingInfoResponse, sending ML model to train.
After receiving UE-DMEinferInfoResponse, sending ML model to Infer.

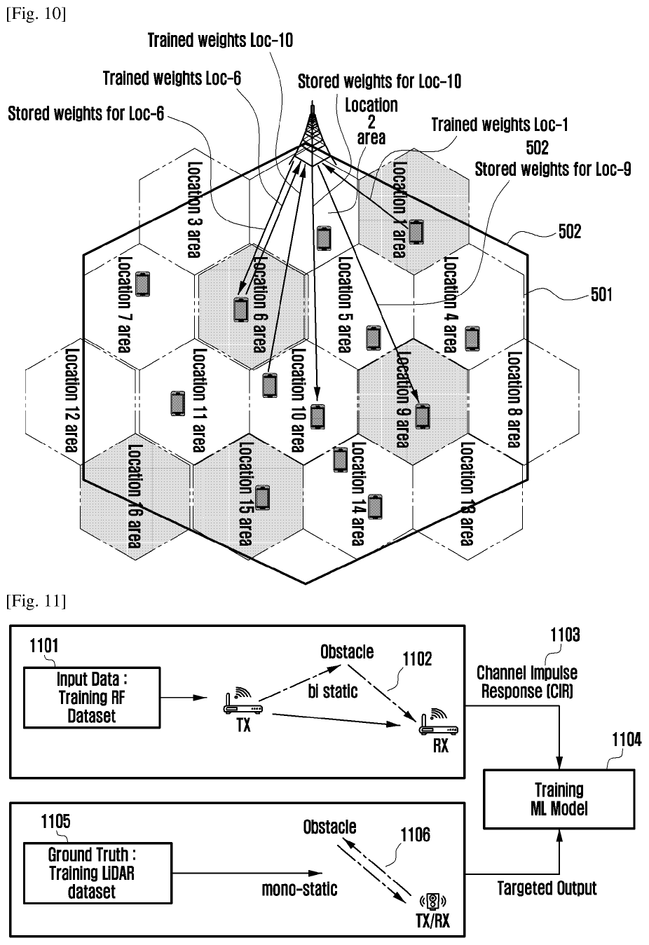

FIG. 10 is an example illustrating the base station that is connected with multiple UE (120) during the training Phase of ML model, according to the embodiments as disclosed herein.

In an embodiment, the cell area of BS is divided into multiple (total N areas) smaller areas as shown in the FIG. 10 as Location area 1 to 16. During the start of the training phase, the BS provide the random weights to the UEs and also the ML model type.

UEs then train the ML model and provide the weights to the BS. Further, the BS store the weight and also the information on the location area.

In an embodiment, when a new UE (120) comes to a location area, the BS provides the stored weights and then the new UE (120) train the ML model and provide the trained weights to the BS. BS updates the weights for the location. In each of the smaller location areas including indoor (501) and outdoor (502), UEs train the ML model and provide the training weights to the BS.

The Information-Exchange during the training phase are follows:
BS->UE (120): Request for DME-training-info
UE (120)->BS: Location

BS decides the location area for the UE (120).
BS->UE (120): 1. Stored weights for the location area and
2. the ML model type
UE (120) trains the ML model using MSPs from pre-processing
UE (120)->BS: Trained weights for the location area

BS stores the weights for the location area

Information exchange for depth map estimation model at UE (120) are follows:
UE (120)->BS:
1. Location
2. Request for model weights: DME-parameters

BS decides the Location area

BS->UE (120): stored weights are transferred for the location area

UE (120) run the ML model [B2] using MSP (mono-static power) from pre-processing [B1] and predicts the depth map.

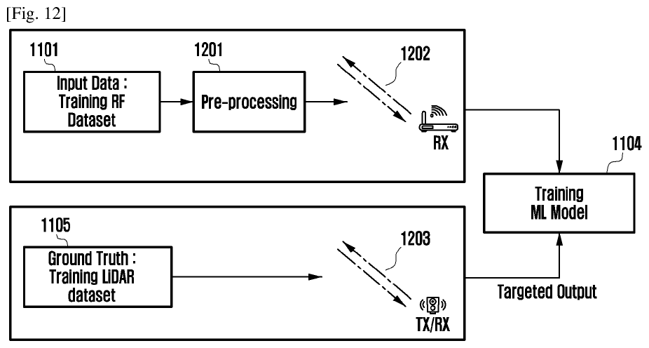

FIG. 11 is a schematic diagram illustrating conversion of the bi-static format data to the mono-static format data, according to the embodiments as disclosed herein.

In an embodiment, the ML Model is trained by using input RF dataset (at 1101) by taking training lidar data as ground truth for training (at 1105).

The input RF data has the transmission & reception at physically separate locations also known as bi static mode (at 1102), whereas Lidar sends and receives laser signals from the same location also known as mono-static mode. Hence, to make both data standardize for training, the proposed system converts bi-static RF data into mono-static data (at 1106).

In an embodiment, in Bi-static format, the RF signal from TX reflects from obstacle and then travels to RX. The proposed system intend to estimate the depth map of the environment by solving for the location of these obstacles.

In an embodiment, the input to the ML model is RF data which is channel impulse response (CIR) (1103) and the Output is LiDAR point cloud. Hence a Pre-processing is required to handles the deterministic aspects of transforming MIMO channel data which is in bistatic format to mono-static format to make ML model learning faster & understandable.

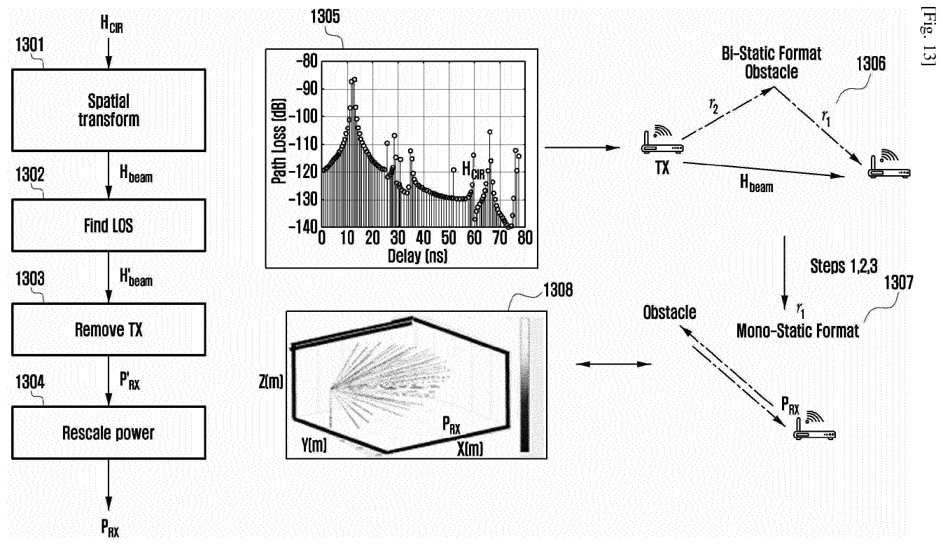

FIG. 12 is a schematic diagram illustrating the conversion of the bi-static format data to the mono-static format data with pre-processing, according to the embodiments as disclosed herein.

The Pre-processing step 1201, handles the deterministic aspects of transforming MIMO channel data which is in bistatic format to mono-static format. This makes ML model learning faster and understandable.

At each RX location (at 1202), transforms bi-static RF data to mono-static format (1203). At 1104, training ML model by fitting it to similarly structured LiDAR ground truth.

Steps involved in pre-processing is follows:

$$Input {H}_{CIR} : TX Ant \times RX Ant \times Delay$$

$$( {nH}_{TX} \times {nV}_{TX} ) \times ( {nH}_{RX} \times {nV}_{RX} ) \times Delay$$

Channel impulse response 5D complex
Output P_{RX}: AoA×Delay
θ_{AoA}×Φ_{AoA}×Delay
Mono-static power 3D real

The proposed method makes the training part of the ML model simpler and ex-plainable. This avoids model to learn itself about existence of MIMO TX and its location and other features through a large amount of training data that result is not guaranteed and depends on DL architecture.

In an embodiment, the proposed system handles the deterministic aspects of model fitting like data transformations outside the DL model.

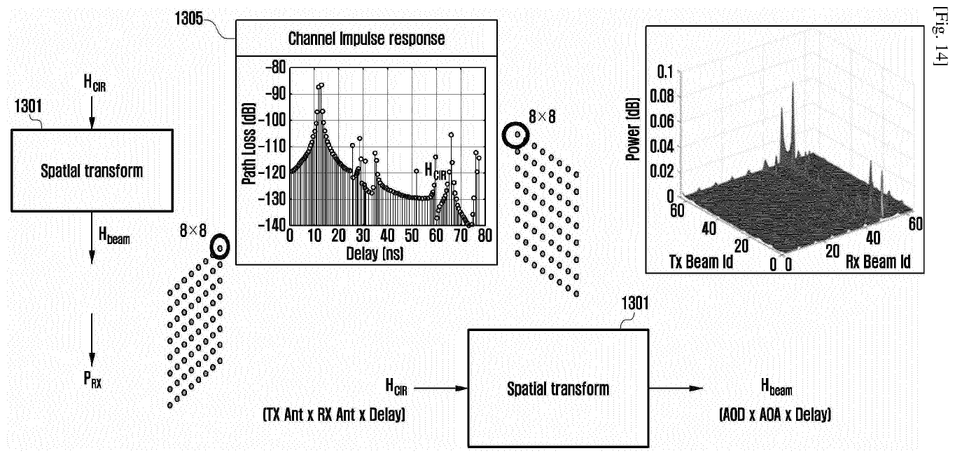

FIG. 13 is a schematic diagram illustrating overview of the pre-processing, according to the embodiments as disclosed herein.

Referring to FIG. 13, the plot (of P_{Rx}) shows pre-processed data for one RX location and power at RX across 64 different Angle Of Arrivals (AOAs) and 100 delays in each direction. The RF data (P_{RX}) is similarly structured as LiDAR data (both are in monostatic format) which makes easier for ML model to fit RF data to LiDAR ground truth data, where FIG. 14 to FIG. 20 discloses the steps involved in detail.

FIG. 14 is a schematic diagram illustrating the pre-processing with a spatial transform (1301), according to the embodiments as disclosed herein.

In an embodiment, the proposed system performs pre-processing to perform spatial transform (1301) on the input channel impulse response (1305). The proposed system transforms signal data from antenna space to angular beam space. The spatial transform (1301) helps to get a sensing framework from communication framework. A plot of matrix H_beam for one delay where each entry represents power for the AOA×angle-of-departure (AOD) beam pair.

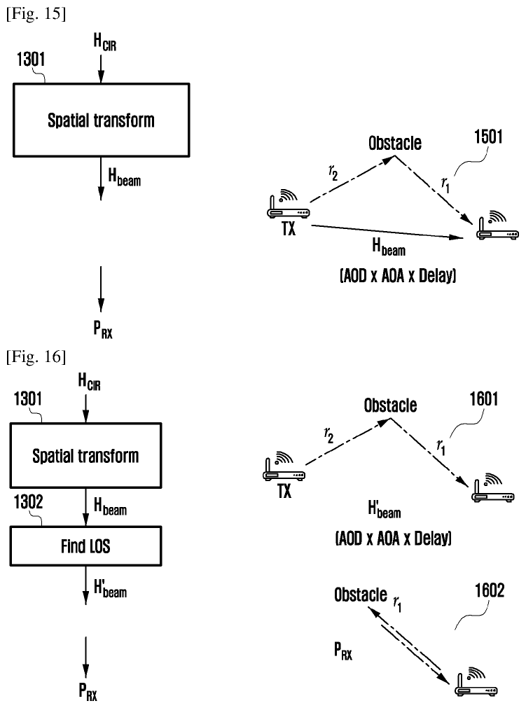

FIG. 15 is a schematic diagram illustrating the pre-processing with spatial transform (1301) and AOA information, according to the embodiments as disclosed herein.

The proposed system moves an antenna space to angular space by performing 2D-FFT on channel response H_CIR. Where TX antenna dimension to get the AoD and RX antenna dimension to get the AoA.

$$TX Ant ( {nH}_{TX} \times {nV}_{TX} ) 〈 - 2 D - 〉 FFT AoD ( {θ}_{AoD} \times {Φ}_{AoD} )$$

$$RX Ant ( {nH}_{RX} \times {nV}_{RX} ) 〈 - 2 D - 〉 FFT AoA ( {θ}_{AoA} \times {Φ}_{AoA} )$$

The matrix H_{beam} gives us the power of reflections at points separated in distance by 0.17 m or 17 cm & on avg. in angle by 22.5 deg across azimuth & elevation
Delay

$${T}_{s} \frac{1}{1.76} ns$$

Distance resolution 0.17 m
Horizontal Ant (nH) 8=>Azimuth resolution of 22.5 o (Avg.)
Vertical Ant (nV) 8<=>Elevation resolution of 22.5 o (Avg.)

In an embodiment, the H_beam is transform into mono-static format (i.e as if the transmission & reception occur at RX.), where a first step in the transformation is to find LOS path.

FIG. 16 is a schematic diagram illustrating the pre-processing with finding the LOS, according to the embodiments as disclosed herein.

In an embodiment, the proposed system selects the beam that has at least one of higher power, lower delay, tighter beamwidth to find the LOS (1302). In an embodiment LOS path travels directly from TX to RX and it does not have information about environment. Hence the proposed system removes those LOS entries from H_beam and stores the LOS path parameters separately as they give location and orientation information of RX which will be used in subsequent steps.

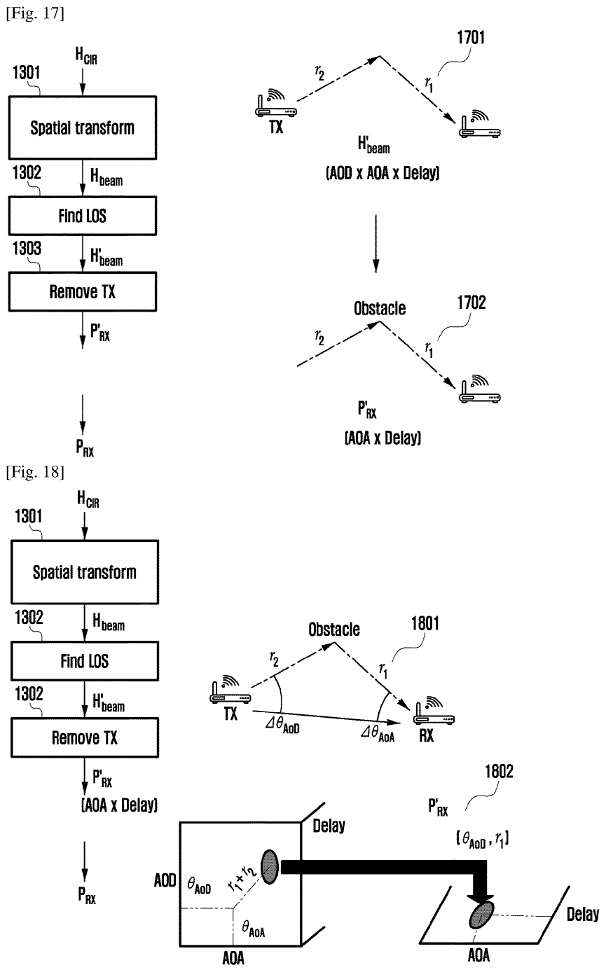

FIG. 17 is a schematic diagram illustrating the pre-processing with removing effort of transmission (at 1303), according to the embodiments as disclosed herein.

In an embodiment, the purpose of pre-processing is to obtain sensing data in mono-static format which is aligned with output LiDAR format. Through the mono-static format, the proposed system mean the RF signals are transmitted and received at RX location. Whereas in the Bi-static format, the RF signals are transmitted from a TX situated at different location and received at RX location. Hence, to transform Bi-static format (at 1701) to mono-static format the proposed system (at 1303) removes the effect of TX (at 1702) in H _{beam}′

In the matrix H, multiple entries in AOD dimension are projected onto delay dimension.

$${H}_{beam}^{′} @ ( {Θ}_{AoD} , {Θ}_{AoA} , \frac{{r}_{2} + {r}_{1}}{c} ) →︀ {P}_{RX}^{′} ( {Θ}_{AoA} , \frac{{r}_{1}}{c} ) \qquad ( 1 )$$

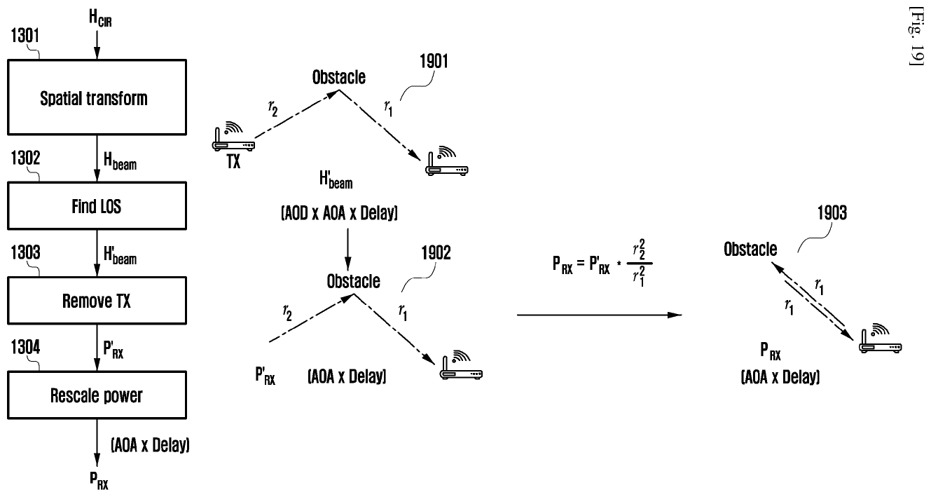

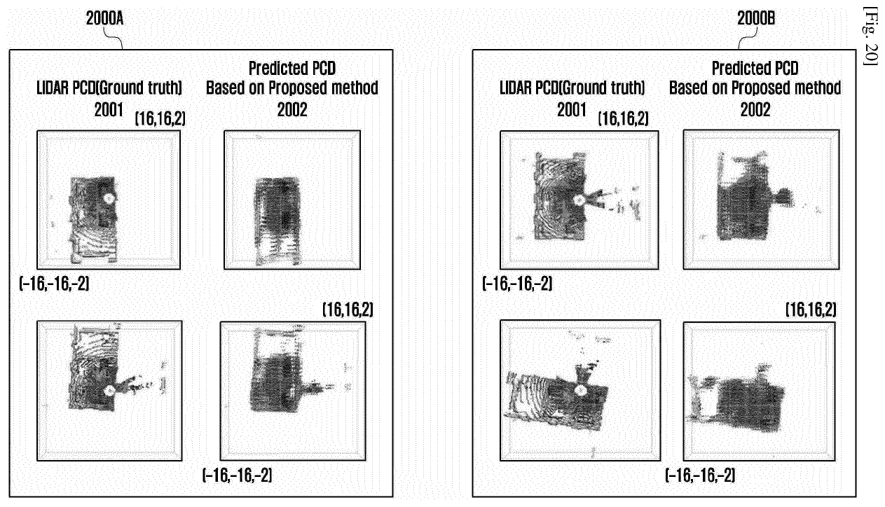

FIG. 18 is a schematic diagram illustrating the pre-processing with the removing effort of transmission and the angle of arrival information, according to the embodiments as disclosed herein.

In an embodiment, the signal shown in FIG. 18 departs TX travels r2 distance hitting an obstacle and then travels r1 distance before arriving at RX. The signal travels r1+r2 distance from TX. Hence the proposed system shifts the delay of this entry in H_beam from r1+r2 to r1 so that it appears to arrive at RX directly from reflection point. Thus the proposed system calculates ratio r2/r1 using the below formula:

$$Calculate \frac{{r}_{2}}{{r}_{1}} = \frac{sin ( {ΔΘ}_{AoA} )}{sin ( {ΔΘ}_{AoD} )} \qquad ( 2 )$$

In an embodiment, a triangle (1801) made from the LOS path and the current reflection, the angle delta AOD is difference between Angle of departure of LOS and of the current reflection. Delta AOA can be defined similarly. Here we use LOS parameters from FIG. 17. Applying sine theorem the proposed system obtains the ratio r2/r1 as ratio between sines of delta AOA to delta AOD (at 1802). The the proposed system projects (at 1802) entries in AOD dimension to appropriate delay to get power map from RX perspective.

FIG. 19 is a schematic diagram illustrating the pre-processing with the rescale power (1304), according to the embodiments as disclosed herein

In an embodiment, the proposed system removed the effect of TX (at 1303 and also shown as the transition from 1901 to 1902) in delay and angular dimension but the power obtained is still related to the distance travelled in bi-static format. Further, the proposed system rescale the power (at 1903) based on the distance travelled in mono static format so that the reflections appear to travel the Receive path twice.

The proposed system performs by scaling the power of reflections P′_{RX} by

$$( \frac{{r}_{2}}{{r}_{1}} )$$

so that it appears to have travelled (r₁, r₁) instead of (r₁, r₂). The distance travelled in Bi-static format is r₂+r₁, and in Mono-static format is 2r₂. Thus the delay and power of the received signal (pre-processed signal) appears to be in mono-static format (same as LiDAR).

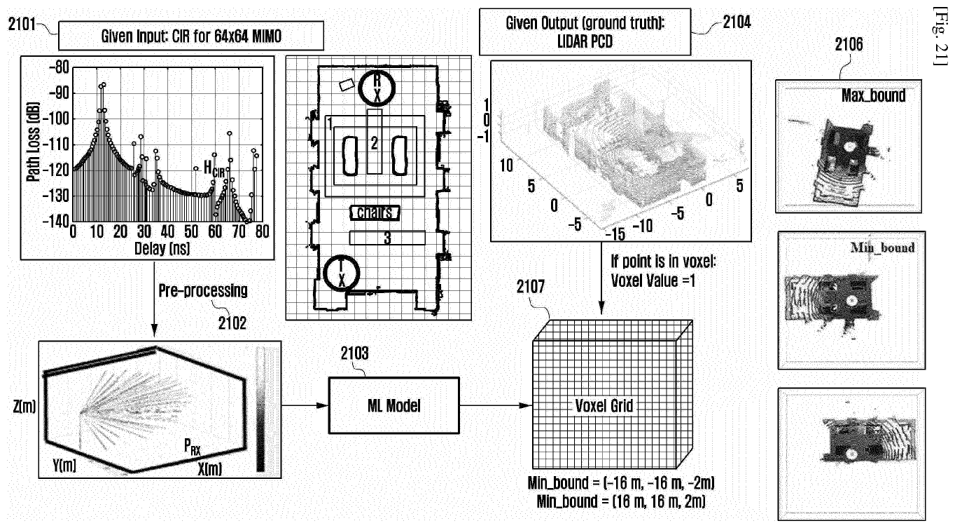

FIG. 20 is a schematic diagram illustrating the comparison of LIDAR PCD and PCD of the proposed method, according to the embodiments as disclosed herein.

Referring to FIG. 20 discloses the comparison of LIDAR PCD (2001) and PCD of the proposed method (2002) with two samples (2000A) and (2000B). The proposed system returns LIDAR-like high resolution point clouds. The change in perception, is shown even when the Tx and Rx locations are unknown.

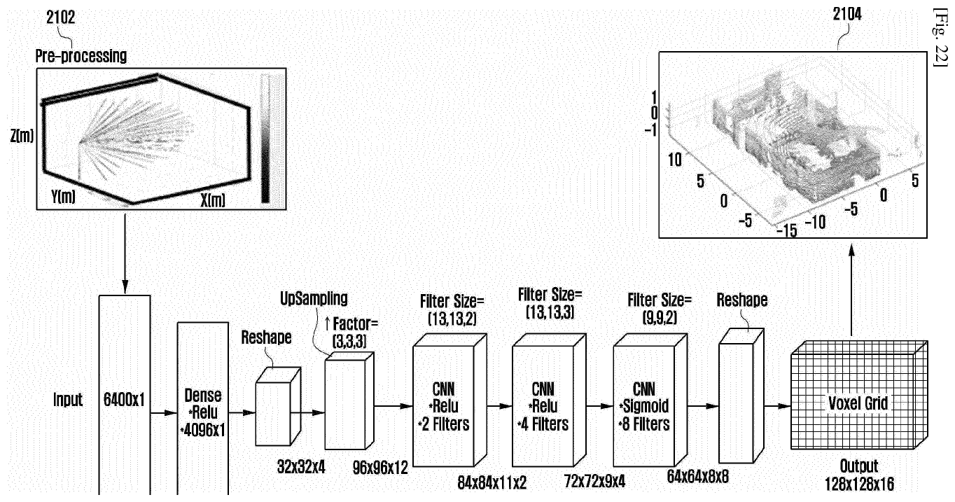

FIG. 21 is a schematic diagram illustrating an input and output for the ML model training, according to the embodiments as disclosed herein. For the ML model training, input data (2101), which is channel impulse response at Rx in bi-static format and output data (2104), which is LIDAR Point cloud data of the surrounding as seen by the Rx, is given for multiple locations across the room. The perception of the room as seen by Rx changes with the change in Rx location and orientations. The output data (2106) displays the snapshots of output data across locations to explain the behaviour. The output LIDAR PCD (2014) is converted to voxel grid for ML model training and pre-dictions, where the voxel grid is the 3-D grid with binary entries for each surrounding locations. In Voxel grid, the entry ‘O’ represent the absence of an obstacle for the location and ‘l’ represents the presence. Further, higher the size of voxel grid (2107), complexity of the ML model will be lower, but resolution of the output is also lower, thus there is a trade-off.

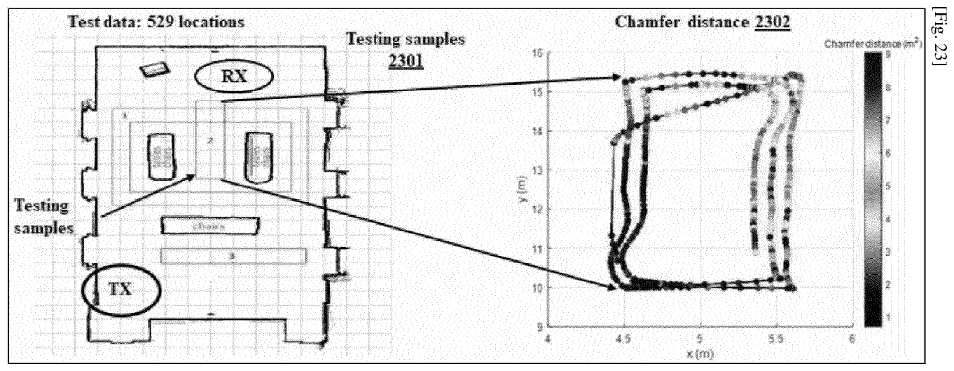

FIG. 22 is a schematic diagram illustrating a ML model architecture, according to the embodiments as disclosed herein.

In an embodiment, Input for the ML model is MSP in N directions, and for each direction, MSP is available for M range points. Here, N=64 and M=100 and thus input size is 6400 values of MSP. The proposed system apply a dense layer on the input which is followed by Up-sampling layer. The proposed system uses up-sampling layer as the input to output size is 3% here where LIDAR point cloud has 128×128×16 voxels. Further, the proposed system apply couple of CNN layers to draw the Cor-relation in reflections, which exists in close neighborhood. Further, the proposed system uses sigmoid activation to predict either 0 or 1 for each voxels of voxel grid, which provide the detail whether an obstacle is present or not in the voxel.

In an embodiment, the custom loss function is binary cross entropy with weights where [symbol] ₁=10 and [symbol] ₒ=1. As the output voxel grid is sparse, training is skewed towards the label ‘1’.

$$L = - \frac{1}{N} {\sum }_{i = 1}^{N} ( {w}_{1} * {y}_{i} log ( p ( {y}_{i} ) ) + {w}_{0} ( 1 - {y}_{i} ) log ( 1 - p ( {y}_{i} ) ) ) \qquad ( 3 )$$

Details of dataset with testing samples (2301) is follows:
Total training samples: 3400 samples
Arca 1:2400 samples
Arca 3:1000 samples
Validation samples: 350 (consisting of both the areas)
Test data: 529 samples of Area 2
Details of optimizer is follows:
Adam with learning rate of 0.0005
Decay rate: 0.9 every 10000 steps
Epochs=100, batch size: 32

FIG. 23 is a schematic diagram illustrating testing samples with error analysis, according to the embodiments as disclosed herein.

In an embodiment, a chamfer distance (2302) measures discrepancies between point clouds. The chamfer distance (2302) is measured using the below equation:

$${d}_{CD} ( {S}_{1} , {S}_{2} ) = \frac{1}{\vert {S}_{1} \vert} {\sum }_{x ∈ {S}_{1}} {min}_{y ∈ {S}_{z}} {‖ x - y ‖}_{2}^{2} + \frac{1}{\vert {S}_{2} \vert} {\sum }_{y ∈ {S}_{2}} {min}_{x ∈ {S}_{1}} {‖ x - y ‖}_{2}^{2} \qquad ( 4 )$$

The chamfer distance (2302) for testing data 1 is follows:
Average Chamfer distance=2 m² which is good for the room of size 16 m×16 m×4 m
Average Chamfer distance=1 m² for the samples which are closer to the Tx.
The chamfer distance (2302) for testing data 2 is follows:
Average Chamfer distance=1.5 m² for voxel-size=0.25 m
Average Chamfer distance=2.2 m² for voxel-size=0.5 m

In an embodiment, the depth map contains the 3-D information of the environment with fine resolution from the receiver viewpoint. The proposed system enables the various imaging applications such as AR, VR, simultaneous localization and mapping (SLAM), 3-D scanners, and sensing applications such as activity recognition. Traditionally, LiDAR and camera have been used for estimating the 3-D depth map. The LiDAR transmits high frequency laser beams to estimate the depth map. The proposed system uses existing communication infrastructure for sensing to sense the environment with good spatial resolution compared to the legacy system because of higher carrier frequency and more number of antenna elements. The proposed system estimate depth map using existing communication signals and creates the digital twin using RF signals implies sensing the whole room having hundreds of objects. Thus, the proposed system is no longer rely only on the handcrafted features for inferences as this problem is of higher complexity and scale. The proposed system first perform pre-processing and then input the processed data to ML model to target the LiDAR point cloud data (PCD). The proposed system is first of its kind that generates LiDAR like high resolution point clouds with low resolution RF data in terms of range and angle. The proposed system also propose the information exchanges between BS and UE (120), which are needed to realize this solution into next-generation wireless systems.

In an embodiment, the depth map contains the 3-D information of the environment with fine resolution from the receiver viewpoint. Unlike traditional wireless sensing, which senses lower dimensional outputs such as location, creating a digital twin using RF signals implies sensing a whole room having hundreds of objects. The proposed system is no longer rely only on the handcrafted features for inferences as this problem is of higher complexity and scale. The proposed system obtains the higher resolution depth map from the lower resolution RF signal and it is not tractable. The proposed system thus uses AI for estimating the depth map and even for the AI, we pre-process the input, which brings the input in the same format as the LIDAR output and also makes the learning tractable.

In an embodiment, the ML model architecture that transforms the low-resolution, lower dimensional input data or MSP into higher resolution, feature rich LiDAR data that captures surfaces of the objects, obstacles, people and the like in the surrounding environment in intricate detail via the dense point clouds. The sensing capability of the proposed system is several orders beyond elementary applications like counting people in room, locating a specific object and the like that has been traditional done using wireless sensing.

In an embodiment, the DME is a fundamental block in building AR/VR applications on both devices and cloud. Therefore finding efficient ways to implement DME in low-power, low-latency, low complexity-compute is essential to scaling AR/VR applications to the UEs. Additionally in conventional methods and systems each sample from camera, LIDAR are of such high resolution and size that processing them on UE or transferring them to BS/cloud requires more computational resources, consuming power and time. However the proposed method, uses the low-resolution RF channel data which is already processed for communication purposes for Depth Map Estimation adds negligible load on resource usage.

The metaverse applications, requires high throughput on backhaul as it is used for streaming the spatial information of user and surroundings from camera/LIDAR sensors. The requirement is brought down by several orders by using RF2LiDAR platform that requires sharing RF sensing data (i.e MSP info.). The proposed system and method utilizes existing 3GPP protocols to extract 3D information of the environment through RF2LiDAR platform and, re-use existing communication infrastructure like spectrum, Base-stations etc., to perform sensing.

The LIDAR data has much higher resolution than RF data in terms of range and angle as in table-I. Further, Lidar is at higher frequency and is guided by laser beam, while RF sensing limited by sampling rate and no. of antennas. Further Lidar gives more reflections compared to RF sensor with Tx and Rx locations are unknown. In an embodiment, For the training an ML model, Input dimension is quite lower than the output dimension (I/o=3%).

TABLE 1

| | RF data | LIDAR Data |
|---|---|---|
| Range resolution | 0.17 m | 10\hat{ }−6 m |
| Angle resolution | Low (~22.5°) | High |
| I/O Dimension | 6400 × 1 | 2, 62,000 voxels(voxel grid: |
| | | 128 × 128 × 16) |

In an embodiment, the SLAM-like global training to coalesce insights from wireless data collected at different locations by building on the proposed one-to-one RF to LiDAR mapping.

Applications of the proposed system in next gen communication systems is follows:
The digital twin is used to solve problems like beam selection virtually without ever sending actual beams in physical environment in Next-Generation communication systems or 6G.
The proposed system have enabled inference from communication signal i.e. ISAC, and does not require specialized equipment unlike LiDAR, radar,3D camera in Next-Generation communication systems or 6G for sensing purposes.
For business use-cases like Self-updating 6G network, smart cities, IoT, AR/VR glasses & applications, metaverse and the like. The proposed system enables the various applications such as virtual beam selection (without even measuring the physical beam), digital twin for next gen wireless system. The proposed system can be used in imaging applications such as AR, VR, simultaneous localization and mapping (SLAM), 3-D scanners, and sensing applications such as activity recognition.

Applications of the proposed system in bridging between wireless and vision fields is follows:
The proposed system has enabled the generation of LiDAR-like high resolution 3D point clouds from this readily available RF data and leverage this platform to act as a bridge between wireless and vision fields.
The RF2Lidar can then build multiple sophisticated applications across fields of wireless communications, wireless sensing and 3D vision.
An AR/VR applications can be enabled in legacy phones without expensive & specialized hardware like AR glasses and 3D sensors like lidar, 3D camera.

Applications of the proposed system in low-cost Solution is follows:
RF channel data is readily available in any communication enabled UE (120). Existing RF signal chain and 3GPP protocols are enough to extract 3D information of the environment through RF2LiDAR platform.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method of a network node (110) for generating a depth map of an environment in a wireless communication system, the method comprising:
training at least one untrained machine learning (ML) model for at least one sub-cell area;
transmitting a request for at least one sub-cell area identifier to a User Equipment (UE (120));
receiving a response including the at least one sub-cell area identifier and input data corresponding to the at least one sub-cell area identifier;
wherein the input data is a sensing data of the environment of the at least one sub-cell area; and
generating the depth map of the at least one sub-cell area by inputting the input data of the at least one sub-cell area identifier in at least one trained ML model.

2. The method as claimed in claim 1, wherein training the at least one ML model for the at least one sub-cell area, comprising:
transmitting a location request for the at least one sub-cell area identifier of the at least one sub-cell area to the UE (120);
receiving a location response including the at least one sub-cell area identifier of the UE (120);
transmitting the at least one untrained ML model corresponding to the at least one sub-cell area identifier to the UE (120) for training; and
receiving the at least one trained mode corresponding to the at least one sub-cell area identifier from the UE (120).

3. The method as claimed in claim 1, wherein training the at least one untrained ML model is updating at least one of parameter by the UE (120) based on the sensing data.

4. The method as claimed in claim 1, wherein the network node (110) stores plurality of trained ML models of plurality of sub-cell areas, wherein the network node (110) uses the stored plurality of trained ML models for virtually selecting beam without sending actual beams in physical environment.

5. A method of a user equipment (UE (120)) for generating a depth map of an environment in a wireless communication system, comprising:
requesting at least one trained machine learning (ML) model of at least one sub-cell area by transmitting at least one sub-cell area identifier to a network node (110);
receiving the at least one trained ML model of the at least one sub-cell area corresponding to the at least one sub-cell area identifier from the network node (110);
determining input data by sensing the environment of the at least one sub-cell area; and
generating the depth map of the at least one sub-cell area by inputting the input data in the at least one trained ML model.

6. The method as claimed in claim 5, wherein determining the input data by sensing the environment of the at least one sub-cell area, comprising:
receiving at least one channel data in a bi-static format; wherein the bi-static format includes data of the RF signal that is received directly or indirectly from at least one transmitter; and
determining the input data by converting the channel data from bi-static format to mono-static format.

7. The method as claimed in claim 5, wherein the UE (120) trains at least one untrained ML model during a training phase.

8. The method as claimed in claim 7, wherein training the at least one untrained ML model, comprises:
generating sensing data based on sensing of an environment using the at least one untrained ML model;
validating the sensing data with a Light Detecting and Ranging (LiDAR) data;
determining whether the sensing data meets a threshold; and
performing one of:
updating the parameters in at least one of convolution layers and up-sampling layers of the at least one untrained ML model when the sensing data does not meets the threshold; or
considering the at least one untrained ML model as trained ML model when the sensing data meets the threshold.

9. A network node (110) for generating a depth map of an environment in a wireless communication system, the network node comprising:
a memory;
a processor; and
a network node depth map controller (114), communicatively coupled to the memory and the processor, configured to:
train at least one untrained machine learning (ML) model for at least one sub-cell area;
transmit a request for at least one sub-cell area identifier to a user equipment (UE (120)) (120);
receive a response including the at least one sub-cell area identifier and input data corresponding to the at least one sub-cell area identifier;
wherein the input data is a sensing data of the environment of the at least one sub-cell area; and
generate the depth map of the at least one sub-cell area by inputting the input data of the at least one sub-cell area identifier in at least one trained ML model.

10. The network node (110) as claimed in claim 9, wherein train the at least one ML model for the at least one sub-cell area, comprising:
transmit a location request for the at least one sub-cell area identifier of the at least one sub-cell area to the UE (120);
receive a location response including the at least one sub-cell area identifier of the UE (120);
transmit the at least one untrained ML model corresponding to the at least one sub-cell area identifier to the UE (120) for training; and
receive the at least one trained mode corresponding to the at least one sub-cell area identifier from the UE (120).

11. The network node (110) as claimed in claim 9, wherein the at least one untrained ML model is trained by updating at least one of parameter by the UE (120) based on the sensing data.

12. The network node (110) as claimed in claim 9, wherein the network node (110) stores plurality of trained ML models of plurality of sub-cell areas, wherein the network node (110) uses the stored plurality of trained ML models for virtually selecting beam without sending actual beams in physical environment.

13. An user equipment (UE (120)) for generating a depth map of an environment in a wireless communication system, the UE comprising:
a memory;
a processor; and
an UE depth map controller (124), communicatively coupled to the memory and the processor, configured to:
request at least one trained machine learning (ML) model of at least one sub-cell area by transmitting at least one sub-cell area identifier to a network node (110);
receive the at least one trained ML model of the at least one sub-cell area corresponding to the at least one sub-cell area identifier from the network node (110);
determine input data by sensing the environment of the at least one sub-cell area; and
generate the depth map of the at least one sub-cell area by inputting the input data in the at least one trained ML model.

14. The network node (110) as claimed in claim 13, wherein determining the input data by sensing the environment of the at least one sub-cell area, comprising:
receive at least one channel data in a bi-static format; wherein the bi-static format includes data of the RF signal that is received directly or indirectly from at least one transmitter; and
determine the input data by converting the channel data from bi-static format to mono-static format.

15. The network node (110) as claimed in claim 13, wherein the UE (120) trains at least one untrained ML model during a training phase.
